(19) United States
(12) Patent Application Publication
(10) Pub. No.: US 2017/0232547 A1
(43) Pub. Date: Aug. 17, 2017

(54) METHOD FOR IMPROVING QUALITY OF ALUMINUM RESISTANCE SPOT WELDING

(71) Applicant: Novelis Inc., Atlanta, GA (US)

(72) Inventors: XIAO CHAI, Kennesaw, GA (US); JULIO MALPICA, Canton, GA (US); RAHUL KULKARNI, Marietta, GA (US)

(73) Assignee: Novelis Inc., Atlanta, GA (US)

(21) Appl. No.: 15/430,854

(22) Filed: Feb. 13, 2017

Related U.S. Application Data
(60) Provisional application No. 62/295,262, filed on Feb. 15, 2016.

(51) Int. Cl. B23K 11/10

(52) U.S. Cl. CPC B23K 11/10; B23K 2203/10

(57) ABSTRACT

Welding techniques, including, for example, resistance spot welding, can be used to join or weld two or more metal sheets together. A clamping force and an electric current can be applied to two or more sheets to create localized melting that combines the material of the two sheets. Applying a clamping force and a cooling current can include gradually decreasing the amount of the electric current applied to the weld while applying the forging force. By adjusting the amount of the electric current applied to the weld can allow the weld to cool gradually, which may reduce thermal stresses and allow the forging force to close cracks, pores, or otherwise be used to remove or prevent defects formed in the weld.

### CROSS-REFERENCE TO RELATED APPLICATION

This application claims the benefit of U.S. Provisional Application No. 62/295,262 filed Feb. 15, 2016, which is incorporated herein by reference in its entirety.

### FIELD OF THE INVENTION

The present disclosure generally relates to resistance spot welding. More specifically, but not by way of limitation, this disclosure relates to improving the quality of welds for joining metal sheets or metal alloy sheets by removing defects in the welded metal or metal alloy sheet.

### BACKGROUND

Metal manufacturing can involve welding metal sheets or metal alloy sheets together to form various parts or components of a final product. Various techniques or processes, including, for example, resistance spot welding (“RSW”), can be used to weld the metal sheets. RSW can involve positioning metal sheets between electrodes and using the electrodes to apply a clamping force and an electric current to the metal sheets. Heat produced from a resistance of the metal sheets to the electric current, along with the clamping force from the electrodes, can be used to join the metal sheets. During RSW processes, the electric current applied to the metal sheets can cause rapid thermal expansion and contraction of the metal sheets, which can cause one or more defects (e.g., a crack, fracture, or porosity) to form in the weld.

### SUMMARY

The term embodiment and the like terms are intended to refer broadly to all the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

Certain aspects and features of the present disclosure relate to improving the quality of welded metal sheets or metal alloy sheets (e.g., welded aluminum sheets or aluminum alloy sheets) by removing defects in the welded metal or metal alloy sheet. In some examples, welding techniques (e.g., resistance spot welding) can be used to join or weld two or more metal sheets together to form a welded metal sheet. Each of the metal sheets can be of any size. If desired, each of the metal sheets can be treated before being welded together to form the welded metal sheet. For example, each of the metal sheets can have any suitable temper.

For example, a compressive force (e.g., a forging force) and an electric current can be applied to the welded metal sheet. Applying the compressive force and the current can include gradually adjusting (e.g., increasing or decreasing) an amount of the electric current applied to the welded metal sheet while applying an amount of the compressive force to the welded metal sheet. Gradually adjusting the amount of the electric current applied to the welded metal sheet can control a rate at which the welded metal sheet cools. For example, gradually decreasing the amount of the electric current applied to the welded metal sheet can allow the welded metal sheet to cool gradually. Allowing the welded metal sheet to cool gradually may include allowing the welded metal sheet to cool at a rate slower than the rate at which the welded metal sheet would cool in ambient conditions (e.g., room temperatures such as, for example, between approximately 15° C. and 30° C.) or when cooled by contact with liquid-cooled electrodes (e.g., electrodes cooled with water or a combination of water and a coolant, including for example, glycol). Gradually cooling the welded metal sheet while applying a compressive force in tandem can prevent a defect from forming in the welded metal sheet and/or remove a defect in the welded metal sheet. The defect can include a crack, fracture, pore, etc. in the welded metal sheet. The defect can form in a surface of the welded metal sheet or within the welded metal sheet and the presence of the defect may be verified by cross-sectioning the welded metal sheet. In some examples, simultaneously applying the compressive force and a cool down current (e.g., a current that allows the welded metal sheet to cool gradually as described above) can prevent a defect from forming in the welded metal sheet or remove a defect formed in the welded metal sheet. In some examples, metal sheets comprising a metal alloy having a large freezing range and low solidus temperatures (e.g., aluminum or 7xxx series aluminum alloys) may be especially susceptible to the formation of defects in a welded metal sheet and may benefit from the resistance spot welding schedule described herein.

According to one non-limiting example, a first metal sheet and a second metal sheet can be positioned between two or more electrodes (e.g., but not limited to, copper, steel, or tungsten electrodes or any electrodes for supplying a desired conductivity). The first and second metal sheets can be positioned in any orientation, configuration, or direction between the two or more electrodes. For example, the first and second metal sheets can be positioned between the two or more electrodes such that the first and second metal sheets are facing the same direction. In another example, the first and second metal sheets can be positioned between the two or more electrodes such that the first metal sheet is perpendicular to the second metal sheet. In still another example, the first and second metal sheets can be positioned between the two or more electrodes such that the first metal sheet is parallel to the second metal sheet. In some examples, the electrodes can be used to apply a compressive force and an electric current to opposite sides of the first and second metal sheets. A first amount of the compressive force can be applied to the first and second metal sheets to squeeze the metal sheets together. A first level or first amount of the electric current can be applied to the first and second metal sheets while applying the first amount of compressive force. A level or amount of the electric current can correspond to a level of heat or a level of energy and may be sufficient to change a state of the metal sheets. For example, the first level of the electric current may be sufficient to melt (e.g., liquefy) the first and second metal sheets. Melting the first and second metal sheets while applying the first amount of compressive force can weld or join the first and second metal sheets together to form a welded metal sheet.

The amount of compressive force and the level of electric current applied to the welded sheet can be adjusted within a weld schedule. For example, the amount of compressive force or the level of electric current applied to the welded sheet can be adjusted gradually, intermittently, with any increasing or decreasing curve or curve profile, or substantially instantaneously. In some examples, the amount of compressive force and the level of electric current applied to the welded sheet can be adjusted independently. In some examples, the amount of compressive force and the level of electric current applied to the welded metal sheet can be adjusted based on user input or command (e.g., input from a weld controller). For example, the amount of the compressive force can be adjusted from a first amount to a second amount. The second amount of the compressive force may be more than the first amount of the compressive force and sufficient to forge the welded metal sheet. The electric current can be gradually decreased from a first level to a second level over a period of time while forging the welded metal sheet using the second amount of the compressive force. Gradually decreasing the level of the electric current from the first level to the second level over a period of time can be referred to as applying a controlled sloped down electric current. Applying a controlled sloped down electric current to the welded metal sheet can allow the welded metal sheet to gradually cool, which may reduce the rate of solidification of the welded metal sheet. Applying a compressive force to forge the welded metal sheet while applying the controlled sloped down electric current to the welded metal sheet can remove a defect in the welded metal sheet, which can improve a quality (e.g., fracture mode, strength, cosmetic appearance, corrosion performance etc.) of the welded metal sheet.

### BRIEF DESCRIPTION OF THE DRAWINGS

FIG. 1A is an image showing an example of a defect in a weld.

FIG. 1B is an image showing another view of the defect of FIG. 1A.

FIG. 2 is a graph depicting an example of a resistance spot welding schedule including both an amount of compressive force and an amount of electric current applied to metal sheets to form a weld while preventing or removing a defect from the weld, according to one example of the present disclosure.

FIG. 3 is a flow chart depicting an exemplary process for preventing a defect in a weld, according to one example of the present disclosure

FIG. 4A is a schematic perspective view of a weld that includes a defect.

FIG. 4B is a schematic perspective view of the defect of FIG. 4A.

FIG. 5A is a schematic perspective view of another weld that includes a defect.

FIG. 5B is a schematic perspective view of the defect of FIG. 4A.

FIG. 6 is a schematic perspective view of a weld after applying a compressive force and a controlled sloped down electric current to the metal sheet, according to one example of the present disclosure.

FIG. 7 contains pictures of resistance spot welding nuggets formed in three alloy 7075 sheets after applying a compressive force and a controlled sloped down electric current to the metal sheet.

### DETAILED DESCRIPTION

### Definitions and Descriptions

The terms “invention,” “the invention,” “this invention” and “the present invention” used herein are intended to refer broadly to all of the subject matter of this patent application and the claims below. Statements containing these terms should be understood not to limit the subject matter described herein or to limit the meaning or scope of the patent claims below.

In this description, reference is made to alloys identified by aluminum industry designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, the meaning of “a,” “an,” or “the” includes singular and plural references unless the context clearly dictates otherwise.

As used herein, the meaning of “room temperature” can include a temperature of from about 15° C. to about 30° C., for example about 15° C., 16° C., 17° C., 18° C., 19° C., 20° C., 21° C., 22° C., 23° C., 24° C., 25° C., 26° C., 27° C., 28° C., 29° C., or 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100%. For example, barometric pressure can be about 975 mbar, 980 mbar, 985 mbar, 990 mbar, 995 mbar, 1000 mbar, 1005 mbar, 1010 mbar, 1015 mbar, 1020 mbar, 1025 mbar, 1030 mbar, 1035 mbar, 1040 mbar, 1045 mbar, or 1050 mbar.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Certain aspects and features of the present disclosure are directed to improving a quality of a weld in a metal sheet or a metal alloy sheet by removing or preventing defects in the weld. An example of the metal or metal alloy sheet includes, but is not limited to, an aluminum sheet or an aluminum alloy sheet. The defect can include, for example, a crack, pore, or fracture in the weld. In some examples, the defect may be in a surface of the weld or in the body of the weld.

In some examples, a clamping force and an electric current can be applied to two or more metal sheets to form a weld. For example, a clamping force can be applied to the metal sheets to bring the metal sheets into contact with one another. A first level of the electric current that is sufficiently high to melt a portion of the metal sheets can be applied to locally melt the metal sheets, which can weld the metal sheets together. In some examples, the level of the electric current can correspond to an amount of energy or an amount of heat. After the initial welding of the metal sheets, a forging force, along with a reduced electric current, can be further applied to the weld to prevent or remove a defect in the weld. Applying a reduced electric current to the weld can include applying a controlled sloped down current to the weld. Applying the controlled sloped down electric current can include applying a second level of electric current, which is lower than the initial welding current, to the welded metal sheet while applying the forging force. The second level of electric current can be at a level that allows the weld to start to solidify (e.g., transition from a liquid phase to a solid phase). Applying the controlled sloped down electric current can further include gradually decreasing the electric current from the second level of electric current to a third level of electric current. The third level of electric current can be lower than the second level of electric current. In some examples, the electric current can be gradually decreased form the first level of electric current to the third level of electric current over a period of time. Applying the controlled sloped down electric current can also include applying a pulsed current that has a square-wave intended shape, sine-wave shape, or any other shape as necessary for a particular application or the available controls. The square-wave or other pulsed current may vary the applied current, temperature and/or cooling profile of the weld by adjusting a number of pulses per unit time, the time delay between pulses, pulse duration, pulse amplitude, or any combination thereof.

Applying a forging force to a weld while applying a controlled sloped down electric current can prevent or remove defects in the weld. In another example, applying the forging force to the weld while applying the controlled sloped down current can prevent a defect from forming in the welded metal sheet. Preventing the defect from forming in the welded metal sheet can improve strength of welded sheet, fatigue, corrosion, or cosmetic characteristics of the welded metal sheet.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

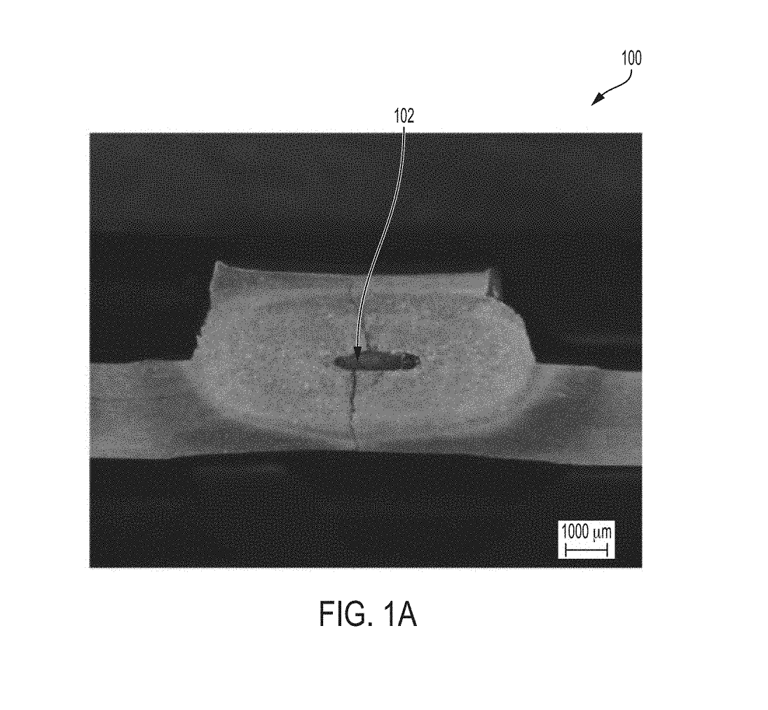

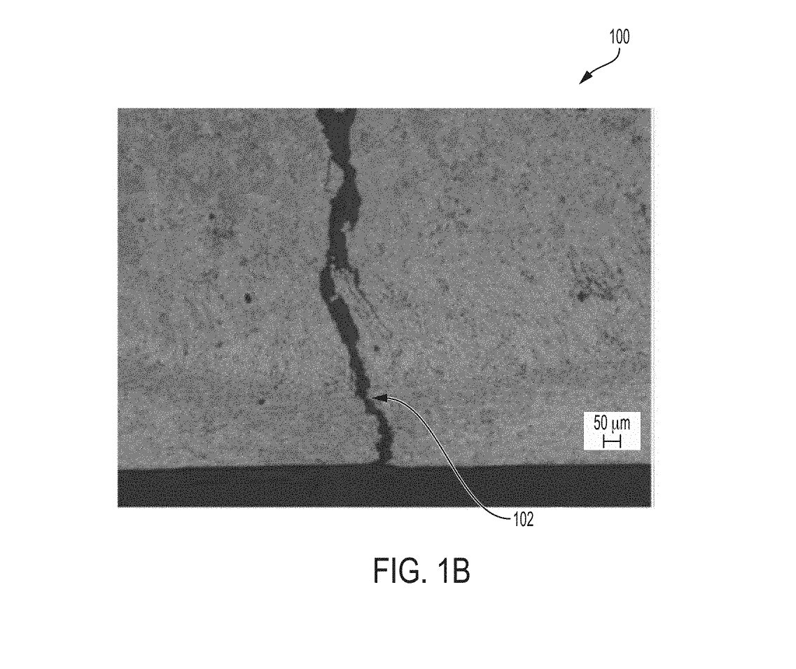

FIG. 1A is an image showing an example of a defect 102 in a weld 100. In the example depicted in FIG. 1A, the weld 100 can be an aluminum weld or an aluminum alloy weld. The weld 100 can be of any shape or size. In some examples, the weld 100 can be formed by welding two or more metal sheets together using various welding techniques or processes, including, for example, resistance spot welding (“RSW”) techniques. Each of the metal sheets used to form the weld 100 can have any size or thickness. As an example, each of the metal sheets used to form the weld 100 can have a thickness between 0 mm and 5 mm. In some examples, each of the metal sheets can be treated before being welded together to form the weld 100. In some examples, each of the metal sheets used to form the weld 100 can have any suitable temper. RSW can involve applying a current to the two or more metal sheets to melt the metal sheets and form a weld between the sheets to join the metal sheets together to form the weld 100. The defect 102 may form in the weld 100 because of thermal expansion and/or contraction during welding operations. For example, a resistance of one or more of the metal sheets to the electric current applied to the metal sheets can produce heat, which may cause thermal expansion or contraction in the weld material and/or the metal sheet around the weld, causing the defect 102 to form in the weld 100. Examples of the defect 102 may include, but are not limited to, a crack, fracture, or porosity in the weld 100.

FIG. 1B is an image showing an enlarged view of the defect 102 in the weld 100 of FIG. 1A. In this example, the defect 102 is a crack in the weld 100.

Referring to FIGS. 1A and 1B, a wide variety of materials may be susceptible to defects during RSW joining operations. During a traditional spot weld process, the metal sheets that are to be joined may be heated rapidly to create localized melting of the sheet material. The molten metal of the metal sheets may then combine to form the weld 100 that will join the metal sheets together. However, after the initial welding process, the weld 100 may cool quickly in ambient conditions (e.g., at room temperatures such as, for example, between approximately 15° C. and 30° C.) or may cool quickly when cooled by contact with liquid-cooled electrodes (e.g., electrodes cooled with water or a combination of water and a coolant, including for example, glycol), which can lead to uneven solidification of the weld 100, thermal stresses, and/or other conditions that may lead to cracking, porosity, and/or fractures in the weld 100. In some examples, materials with a relatively wide freezing range between the solidus and liquidus temperatures and/or that have a relatively low solidus temperature may be especially susceptible to a defect (e.g., the defect 102 in the weld 100). In certain cases, aluminum or aluminum alloys in the 1xxx series, 2xxx series, 3xxx series, 4xxx series, 5xxx series, 6xxx series, 7xxx series, 8xxx series and/or any other aluminum or aluminum alloy materials may be especially susceptible to defect 102 in a weld 100 and may benefit from the resistance spot welding schedule described below. In other examples, any other alloy may be susceptible to a defect in a weld and may benefit from the resistance spot welding schedule described below. Non-limiting examples of other alloys that may benefit from the resistance spot welding schedule described below include, but are not limited to, alloys disclosed in U.S. Provisional Patent Application Ser. No. 62/248,796, filed Oct. 30, 2015, entitled High Strength 7xxx Aluminum Alloys and Methods of Making the Same, the disclosure of which is hereby incorporated herein by reference in its entirety.

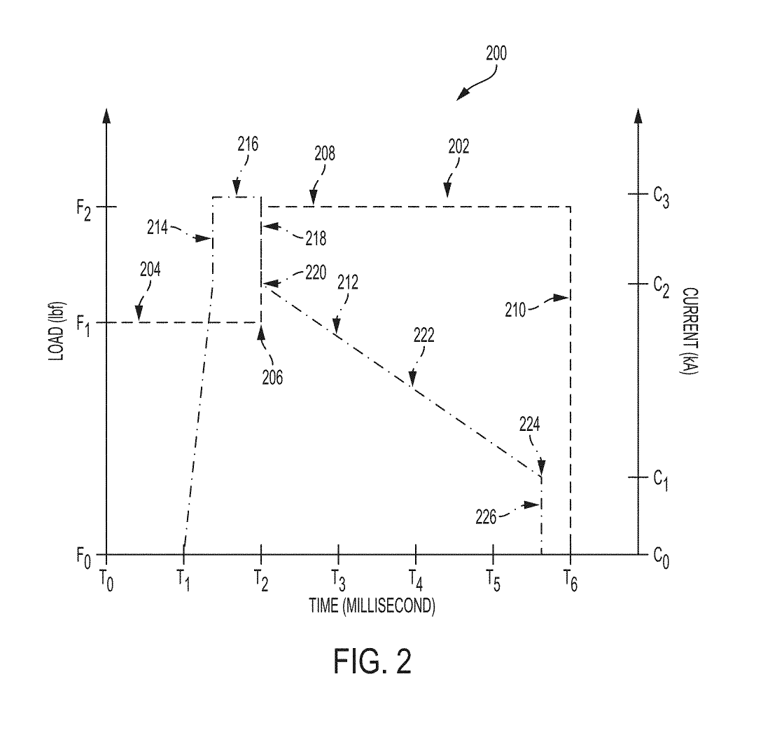

FIG. 2 is a graph depicting an example of a resistance spot welding schedule 200 including both an amount of compressive force 202 and an amount of electric current 212 applied to metal sheets to form a weld while preventing or removing a defect from the weld. The welding schedule 200 may be used in any existing spot welding apparatus, and may not require additional equipment, parts, or machinery beyond that commonly associated with resistance spot welding processes. In the example depicted in FIG. 2, an amount of a compressive force 202 and an amount of an electric current 212 are applied to two or more metal sheets. Each metal sheet can be a metal alloy sheet. In some examples, an amount F₀-F₂ of the compressive force 202 and a level C₀-C₃ of electric current 212 can be applied to the metal sheets over a period of time T₀-T₆. Each amount F₀-F₂ of the compressive force 202 can be any amount of force for compressing or squeezing a metal sheet. As an example, each amount F0-F2 of the compressive force 202 can be between 0 lbf and 3000 lbf. Each level C₀-C₃ of electric current 212 can correspond to any amount of electric current, any amount of energy, or any amount of heat. As an example, each level C₀-C₃ of electric current 212 can be between 0 kiloamperes (kA) and 65 kA. The period of time T₀-T₆ can be any span or duration of time and the span of time between each time period may vary, for example, up to 3000 milliseconds (ms). As an example, the period of time T₀-T₆ can be a duration of 1500 ms.

In some examples, a clamping force 204 can be initially applied to the metal sheets. The clamping force 204 can be a welding force applied to the metal sheets for squeezing the metal sheets together or bringing them into contact with one another. As a non-limiting example, the clamping force 204 can be an amount F₁ of compressive force, which may be approximately 1200 lbf or any suitable amount of force. After the application of the clamping force 204, an amount of the electric current 212 may be increased by an amount 214 at time T₁ to a welding current 216. In the example depicted in FIG. 2, the electric current 212 is ramped up in a manner that corresponds with a linear function. In another example, the electric current 212 may be increased in any manner or according to any function, curve, slope, pulsed, or modulated control strategy. In some examples, the welding current 216 is sufficiently high to cause enough heat in the metal sheets for localized melting to occur. The welding current 216 can be an amount C₃, which may be approximately 30 kA or any suitable current. Melting the metal sheets while applying the clamping force 204 to the two metal sheets can weld or join the metal sheets together while the welding current 216 is applied to the metal sheets from time T₁ to time T₂.

In some examples, after the clamping force 204 and the welding current 216 have sufficiently melted the metal sheets so that the molten material has mixed, a weld puddle may have formed between the sheets of molten metal that will solidify to form the weld. At or around time T₂, the clamping force 204 may be increased at 206 to a forging force 208. In certain non-limiting examples, the forging force 208 may be an amount F₂, which can be 1 to approximately 4 times the clamping force 204. In another example, the forging force may be any amount of force sufficient for forging the metal sheets. As the compressive force 202 is increased to the forging force 208, the welding current 216 may be reduced at 218 to an initial cooling current 220. The initial cooling current 220 may be a level or an amount of electrical current that is sufficiently low that it cannot maintain the whole weld puddle in a molten state, but that maintains a certain amount of heat in the whole weld puddle to prevent cooling and solidification from progressing at the same rate as if the weld material were allowed to cool in ambient air or cooled using liquid-cooled electrodes (e.g., electrodes cooled with water or a combination of water and a coolant, including for example, glycol). As an example, the initial cooling current 220 can be between approximately 20 kA and 30 kA or any suitable current. Cooling the weld material in ambient conditions (e.g., in temperatures between approximately 15° C. and 30° C.) or using liquid-cooled electrodes may cause a defect to form in the weld. The initial cooling current 220 may be decreased at 222 to a final cooling current 224 before being reduced to zero at 226. As an example, the final cooling current 224 can be between approximately 0 kA and 10 kA or any suitable current. The controlled slope down 222 may gradually reduce the amount of heat applied to the weld, thus controlling the drop in temperature of the weld from time T₂ to time T₆. Controlling the drop in the temperature can allow the weld to cool at a rate slower than if the weld material were allowed to cool at an ambient rate (e.g., at room temperature including, for example, between approximately 15° C. and 30° C.) or cooled by contact with liquid-cooled electrodes. During the current slope down at 222, the forging force 208 may be maintained until the release of the finished weld at 210.

Gradually decreasing the level of electric current applied to the welded metal sheet (e.g., from 220 to 224) while applying a constant amount of compressive force (e.g., forging force 208) can allow the welded metal sheet to cool slowly while forging the welded metal sheet using the compressive force. Forging the welded metal while the welded metal sheet cools slowly may allow the compressive force to mitigate defects in the welded metal sheet and/or prevent defects from forming in the welded metal sheet. Mitigating defects in the welded metal sheet and/or preventing defects from forming in the welded metal sheet can produce a welded metal sheet having improved strength, tear down efficiency, cosmetic appearance, or fatigue and corrosion performance.

In some examples, the effect of the described resistance spot welding schedule 200 is that after the initial welding is complete at time T₂, the application of the initial cooling current 220 and the controlled slope down 222 will slow the cooling rate of the weld material to prevent thermal stresses or uneven cooling that may lead to cracks, porosity, fractures, and/or any other weld defects. Furthermore, because the weld material is not fully solidified, the application of a forging force 208 during the controlled cooling stages can impart a compressive stress that may plastically deform the weld to close any cracks, porosities, fractures, and/or other defects while the weld material is in a malleable state. The fully solidified weld may then be free of or substantially free of cracks, porosities, fractures, and/or any other defects.

Still referring to FIG. 2, a number of modifications or adjustments to the exemplary resistance spot welding schedule 200 may be used to adjust the process for a particular application, weld size, material, and/or material thickness. For example, in certain cases, the increase 206 from the clamping force 204 to the forging force 208 may be shifted to be earlier or later than the decrease 218 from the welding current 216 to the initial cooling current 220 or vice versa. In some cases, the forging force 208 may be constant as shown, or may increase, decrease, or vary from about time T₂ to time T₆ as necessary for any particular material, process, or material thickness. Furthermore, the forging force 208 may be determined by a forging displacement, wherein the forging force 208 is varied to maintain specified gap between welding electrodes or a specified amount of plastic or elastic deformation in the weld material. In certain cases, the forging force 208 may be within the range of approximately 1 to 4 times the clamping force 204, and more particularly may be approximately 1.5 times the clamping force 204.

The initial cooling current 220, current slope down 222, and/or final cooling current 224 may also vary in magnitude and from time T₂ to time T₆. For example, the initial cooling current 220 may be maintained at a constant level without the current slope down 222. In some cases, the current slope down 222 may be constant, decaying, may increase in slope, may decrease in slope, may include multiple step downs with constant current steps, and/or take on any shape as desired or required for a particular application. In certain cases, the current slope down 222 may have any value. As an example, the current slope down 222 may have a value of approximately up to 90 kA per second. The current slope down 222 may also be a pulse-width modulated current to provide varying amounts of current, and consequently heat, into the weld material. In certain cases, the initial cooling current 220, current slope down 222, and/or final cooling current 224 may be varied in response to a mathematical model of the cooling rate, solidification, temperature profile, and/or thermal stress profile of the weld material during the welding schedule 200. In other cases, the initial cooling current 220, current slope down 222, and/or final cooling current 224 may be determined by direct measurement of the weld temperature, weld resistance, electrode temperature, and/or any other process parameters that may be measured or calculated.

Regardless of the parameters measured, calculated, or used to determine the amount of energy applied to the weld, the method should produce a temperature change over time in the weld that allows for cooling at a rate that will prevent and/or reduce defects and/or undesirable grain structures. Similarly, the amount of cooling time, T₂ to T₆ in FIG. 2, may also vary depending on the material, application, and/or equipment used. In some cases, the application of the forging force 208, initial cooling current 220, current slope down 222, and/or final cooling current may occur over the time span of up to approximately 10 seconds. In certain cases, the time span may be approximately 1 second.

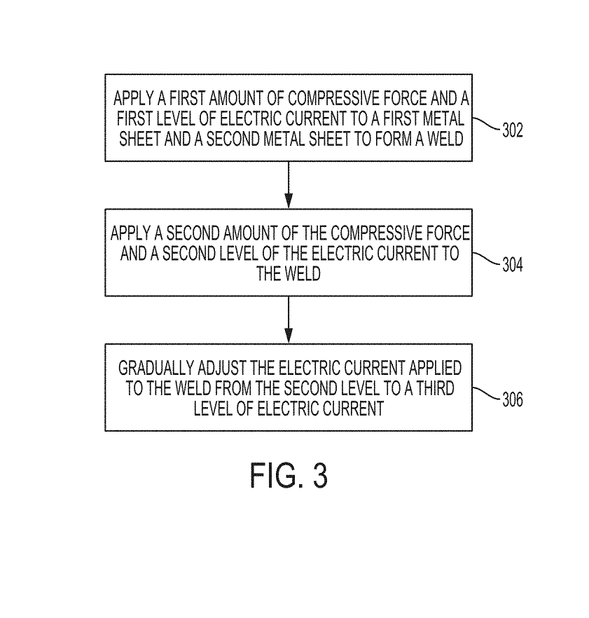

FIG. 3 is a flow chart depicting an exemplary process for preventing a defect in a weld. At block 302, a first amount of compressive force and a first level of electric current are applied to a first metal sheet and a second metal sheet to form a weld. In some examples, the first metal sheet or the second metal sheet can be an aluminum sheet or an aluminum alloy sheet. The first and second metal sheets can be of any shape or size. For example, the first and second metal sheets can each have a thickness between 0 mm and 5 mm. A level of electric current can correspond to an amount of electric current, an amount of heat, or an amount of energy applied to first and second metal sheets. The first amount of the compressive force can be any amount of force for compressing the first metal sheet and the second metal sheet. As an example, the first compressive force can be between 0 lbf and 3000 lbf. The first level of electric current can be any amount of current for melting the first metal sheet and the second metal sheet. As an example, the first level of current can be between 0 kA and 65 kA.

For example, the first and second metal sheets can be positioned between at least two electrodes, such as but not limited to, copper, steel, or tungsten electrodes. The electrodes can be used to apply an amount of pressure or compressive force and an amount of an electric current to opposite sides of the first metal sheet and the second metal sheet. As an example, the electrodes can be used to apply the first amount of compressive force to the first and second metal sheets to squeeze the first and second metal sheets together. The electrodes can also be used to apply the first level of electric current to the first and second metal sheets to melt the first and second metal sheets at a desired welding location. Melting the first and second metal sheets while applying the first amount of compressive force may weld or join the first and second metal sheets together to form a weld at the desired welding location. The weld can be of any shape or size.

In some examples, applying the first level of electric current to the first and second metal sheets can cause thermal expansion or contraction in each of the metal sheets. Thermal expansion or contraction in the first or second metal sheet may cause defects (e.g., a crack, fracture, or a porosity) to form in a surface of the welded metal sheet or in the body of the welded metal sheet.

At block 304, a second amount of the compressive force and a second level of the electric current are applied to the first and second metal sheets at the weld. In some examples, the electrodes can be used to apply the second amount of the compressive force and the second level of the electric current to the weld to forge or shape the weld. In some examples, the second level of electric current can be any amount of electric current. In some examples, the second level of electric current can be less than a previous level of electric current applied using the electrodes (e.g., less than the first level of electric current applied in block 302). The second amount of the compressive force can be any amount of force for compressing the first and second metal sheets. In some examples, the second amount of compressive force can be more than a previous amount of compressive force applied using the electrodes (e.g., more than the first amount of the compressive force applied in block 302). As an example, the second amount of the compressive force can be between 0 lbf and 3000 lbf, or any suitable amount. The second level of electric current can be between 0 kA and 65 kA, or any suitable level. In some examples, increasing the amount of the compressive force applied to the weld while reducing the level of electric current applied to the weld may allow the weld to begin to cool or solidify while the increased amount of compressive force forges or shapes the weld.

At block 306, the electric current applied to the weld is gradually adjusted from the second level to a third level of electric current. The third level of electric current can be any amount of electric current. For example, the third level of electric current can be between 0 kA and 65 kA. In some examples, the third level of electric current can be lower than the second level of electric current. The electric current can be gradually reduced from the second level to the third level over a period of time. Gradually reducing the electric current applied to the weld from the second level to the third level over a period of time can be referred to as applying a controlled sloped down current. Applying a controlled sloped down current can allow the weld material to cool gradually while a compressive force (e.g., the second amount of compressive force applied in block 304) is used to forge the weld and prevent or repair any defects that may occur. Forging the welded metal while the weld material cools slowly may allow the compressive force to close defects in the weld. In another example, a forging force applied to the weld while it cools in a controlled fashion may allow the compressive force to prevent defects from forming in the weld. In some examples, the level of the electric current and the amount of the compressive force may be reduced and jaws controlling the electrodes may be opened for removing the welded metal sheets from between the electrodes after any defects have been removed. For example, the level of the electric current may be reduced to 0 kA and the amount of the compressive force may be reduced to 0 lbf to remove the welded metal sheets from between the electrodes.

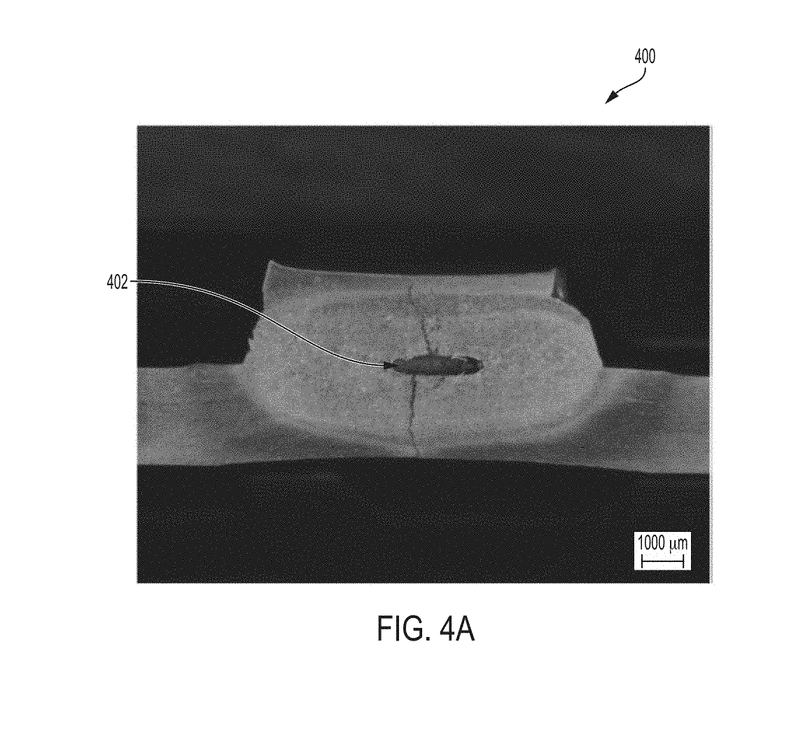

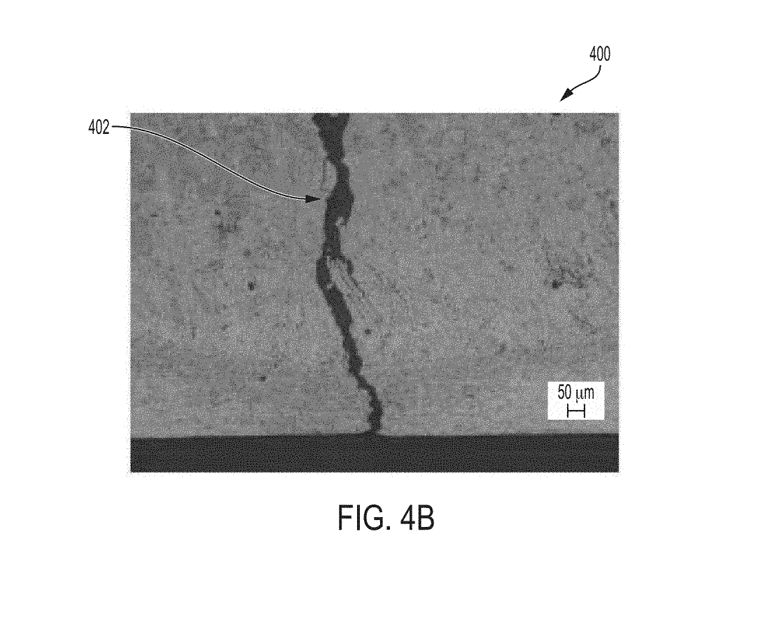

FIG. 4A is a schematic perspective view of a weld 400 that includes a defect 402. In the example depicted in FIG. 4, the weld 400 can be formed according to a conventional weld schedule. The conventional weld schedule can include a weld schedule that includes cooling the weld in ambient conditions (e.g., cooling the weld at room temperatures such as between approximately 15° C. and 30° C.) or cooling the weld using liquid-cooled electrodes. The defect 402 can be a crack on a surface of the weld 400. The weld 400 may also include cracks within the weld and dendritic grain growth, which can cause additional defects to form in the weld 400. FIG. 4B is a schematic perspective view of the defect 402 of FIG. 4A.

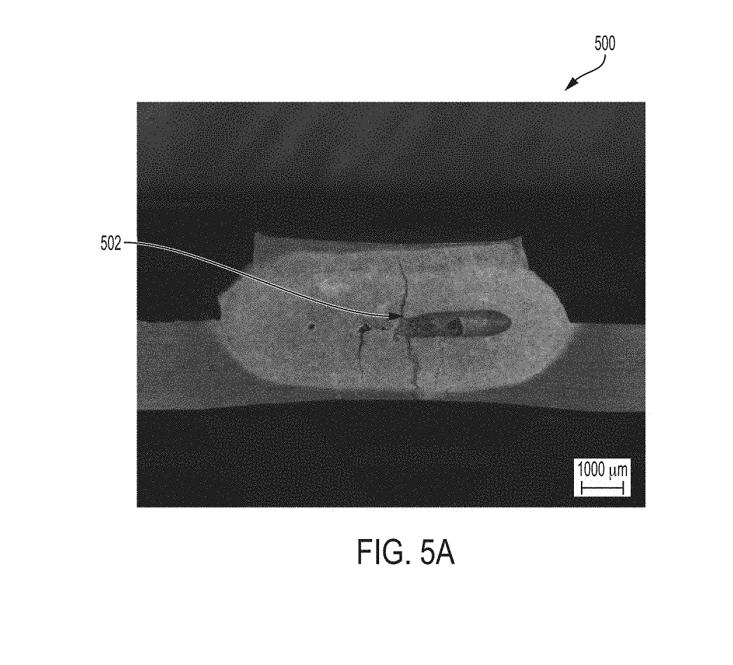

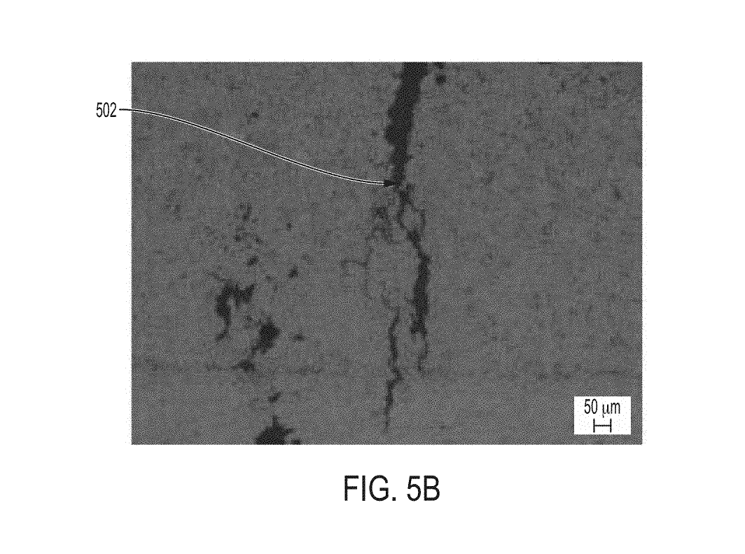

FIG. 5A is a schematic perspective view of another weld 500 that includes a defect 502. FIG. 5B is a schematic perspective view of the defect 502 of FIG. 5A.

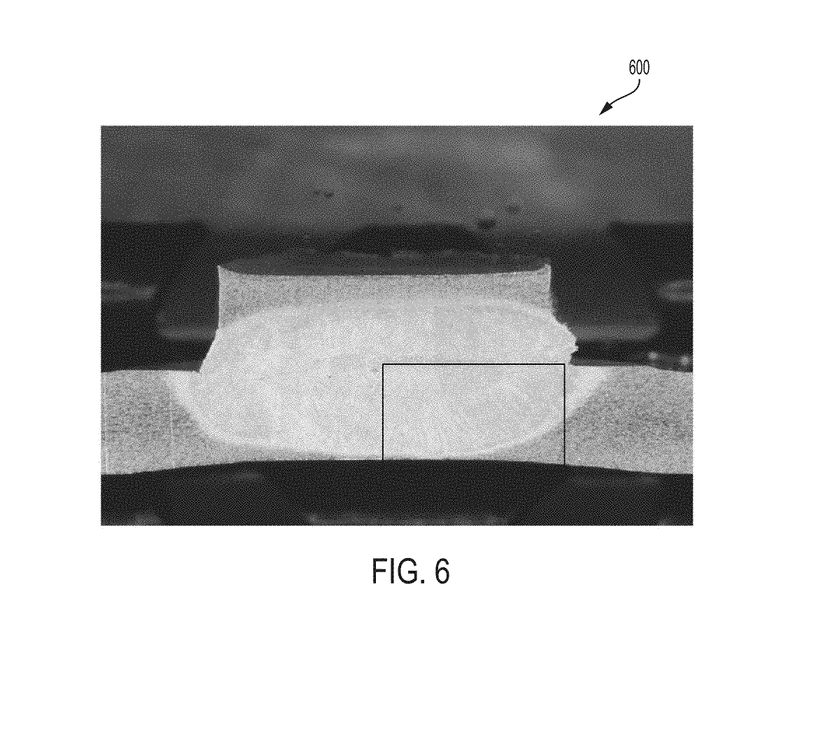

FIG. 6 is a schematic perspective view of a welded metal sheet 600 after applying a compressive force and a controlled sloped down electric current to the metal sheet, as with exemplary resistance spot welding schedule 200 described above with respect to FIG. 2. In the example depicted in FIG. 6, the welded metal sheet 600 does not include any defects. For example, the defect may be removed and/or prevented by applying a forging force and a controlled slope down electric current to the welded metal sheet as described above. As an example, the defect may be removed and/or prevented by forming the welded metal sheet according to the method depicted in the flow chart of FIG. 3.

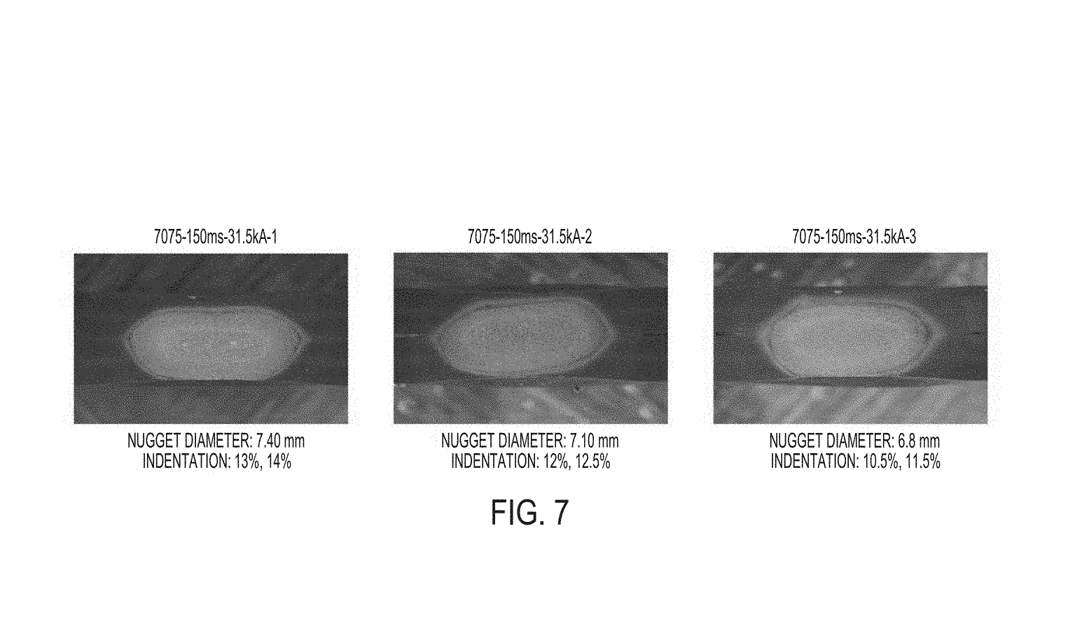

FIG. 7 contains pictures of resistance spot welding nuggets formed in three 7075 aluminum alloy sheets after applying a compressive force and a controlled sloped down electric current to the metal sheet as described herein.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. During the studies described in the following examples, conventional procedures were followed, unless otherwise stated. Some of the procedures are described below for illustrative purposes.

### EXAMPLES

### Example 1

Conventional resistance spot welding was performed on sheets prepared from a 7075 aluminum alloy. Specifically, a pair of opposing welding electrodes was brought into contact with opposite sides of sheet metal layers at diametrically common spots. A compressive force was applied to the sheet metal at 1200 lbf along with an electrical current at approximately 30 kA. The current and the compressive force were held constant for 250 ms, which resulted in the forming of a molten weld pool. The current was then dropped substantially instantaneously from 30 kA to 0 kA and the molten weld pool solidified into a weld nugget while the compressive force was held constant for an additional 50 ms and then dropped gradually from 1200 lbf to 0 lbf over a period of an additional 50 ms. As shown in FIGS. 4A-B, the weld nugget formed from the welding included weld cracks on the weld surface as well as in the weld nugget. Therefore, performing conventional resistance spot welding on an 7075 aluminum alloy can cause a defect (e.g., a crack) to form in the weld.

### Example 2

Conventional resistance spot welding was performed on sheets prepared from a 7075 aluminum alloy. Specifically, a pair of opposing welding electrodes was brought into contact with opposite sides of sheet metal layers at diametrically common spots. A compressive force was applied to the sheet metal at 1000 lbf along with an electrical current at approximately 30 kA. The current and the compressive force were held constant for 250 ms, which resulted in the forming of a molten weld pool. The current was then dropped substantially instantaneously from 30 kA to 0 kA and the molten weld pool solidified into a weld nugget while the compressive force was held constant for an additional 50 ms and then dropped gradually from 1200 lbf to 0 lbf over a period of an additional 50 ms. As shown in FIGS. 5A-B, the weld nugget formed from the welding included weld cracks on the weld surface as well as in the weld nugget. Therefore, performing conventional resistance spot welding on a 7075 aluminum alloy can cause a defect (e.g., a crack) to form in the weld.

### Example 3

Resistance spot welding was performed on sheets prepared from an 7075 aluminum alloy according to the methods described herein. Specifically, a pair of opposing welding electrodes was brought into contact with opposite sides of sheet metal layers at diametrically common spots. A compressive force was applied to the sheet metal at 1200 lbf along with an electrical current at approximately 0 kA. The compressive force was held constant at 1200 lbf for 300 ms while the initial current was held constant at 0 kA for 150 ms. After the first 150 ms, the current was then increased from 0 kA to approximately 30 kA over a period of time. The current was then held constant at approximately 30 kA for a period of 150 ms. After 300 ms, the current was subsequently dropped from 30 kA to approximately 25 kA substantially instantaneously and the compressive force was simultaneously increased from 1200 lbf to 1800 lbf. The current was decreased from 25 kA to 5 kA over a period of approximately 1000 ms while the compressive force was held constant at 1800 lbf. The current was then dropped from 5 kA to 0 kA substantially instantaneously and held at 0 kA for 500 ms. Then the force was dropped instantaneously from 1800 lbf to 0 lbf. As shown in FIG. 6, the welded nugget formed according to the welded schedule disclosed herein does not include any defects. Therefore, performing resistance spot welding on 7075 aluminum alloy sheets according to the methods described herein can prevent a defect from forming in the weld nugget or remove a defect in the weld nugget by applying a forging force and a controlled slope down electric current to the welded metal sheet as described above.

### Example 4

Resistance spot welding was performed on sheets prepared from an 7075 aluminum alloy according to the methods described herein. Specifically, a pair of opposing welding electrodes was brought into contact with opposite sides of sheet metal layers at diametrically common spots. A compressive force was applied to the sheet metal at 1200 lbf along with an electrical current at approximately 0 kA. The compressive force was held constant at 1200 lbf for 300 ms while the initial current was held constant at 0 kA for 150 ms. After the first 150 ms, the current was then increased from 0 kA to approximately 30 kA over a short period of time. The current was held constant at approximately 30 kA for a period of 150 ms. After 300 ms, the current was subsequently dropped from 30 kA to approximately 25 kA substantially instantaneously and the compressive force was simultaneously increased from 1200 lbf to 1800 lbf. The current was decreased from 25 kA to 5 kA over a period of approximately 1000 ms while the compressive force was held constant at 1800 lbf. The current was then dropped from 5 kA to 0 kA substantially instantaneously and held at 0 kA for 500 ms. Then the force was dropped instantaneously from 1800 lbf to 0 lbf. The nuggets formed from the welding in each of the sheets had similar diameters and indentations. As shown in FIG. 7, the welded nuggets formed according to the welded schedule disclosed herein do not include any defects. Therefore, performing resistance spot welding on 7075 aluminum alloy sheets according to the methods described herein can prevent a defect from forming in the weld nugget or remove a defect in the weld nugget by applying a forging force and a controlled slope down electric current to the welded metal sheet as described above.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

That which is claimed is:

1. A method for joining metal sheets comprising:
applying a clamping force to two or more metal sheets;
applying a welding electric current to the two or more metal sheets, wherein the welding electric current heats the two or more metal sheets such that a portion of the two or more metal sheets comprises a molten metal;
applying a forging force to the two or more metal sheets; and
controlling a cooling rate of the molten metal,
wherein the forging force is greater than the clamping force and is applied to the two or more metal sheets before the molten metal solidifies, the cooling rate of the molten metal is slower than a cooling rate of the molten metal in a room temperature environment, and wherein applying the forging force and controlling the cooling rate of the molten metal comprises applying the forcing force and controlling the cooling rate over a period of time until the molten metal solidifies into a weld.

2. The method of claim 1, wherein controlling the cooling rate of the molten metal comprises reducing the welding electric current to a cooling current.

3. The method of claim 2, wherein the cooling current is constant over the period of time.

4. The method of claim 2, wherein the cooling current is reduced over the period of time at a constant rate.

5. The method of claim 2, wherein the cooling current comprises a pulse-width modulated current.

6. The method of claim 2, further comprising:
thermally modeling solidification of the molten metal; and
adjusting the cooling current over the time period according to the thermally modeled solidification of the molten metal such that the cooling rate of the molten metal reduces defects in the weld.

7. The method of claim 1, wherein the period of time comprises approximately 0.5 seconds to approximately 10 seconds.

8. The method of claim 1, wherein the forging force comprises a force that is about 1.1 to about 2 times the clamping force.

9. The method of claim 1, wherein applying the forging force comprises applying a constant compressive force with at least two electrodes to the two or more metal sheets.

10. The method of claim 1, wherein each of the two or more metal sheets comprises an aluminum sheet or an aluminum alloy sheet.

11. A method for preventing defects in a resistance spot weld comprising:
applying a forging force to the resistance spot weld prior to solidification of the resistance spot weld; and
controlling a cooling rate of the resistance spot weld;
wherein the forging force is greater than a clamping force applied during welding, the cooling rate of the resistance spot weld is slower than a cooling rate of the resistance spot weld in a room temperature environment, and applying the forging force and controlling the cooling rate of the resistance spot weld takes place over a period of time until the resistance spot weld solidifies.

12. The method of claim 11, wherein controlling the cooling rate of the resistance spot weld comprises reducing a welding electric current to a cooling current.

13. The method of claim 12, wherein the cooling current is constant over the period of time.

14. The method of claim 12, wherein the cooling current is reduced over the period of time at a constant rate.

15. The method of claim 12, wherein the cooling current comprises a pulse-width modulated current.

16. The method of claim 12, further comprising:
thermally modeling solidification of the resistance spot weld; and
adjusting the cooling current over time according to the thermally modeled solidification of the resistance spot weld such that the cooling rate of the resistance spot weld reduces defects in the resistance spot weld.

17. The method of claim 11, wherein the period of time comprises approximately 0.5 seconds to approximately 10 seconds.

18. The method of claim 11, wherein the forging force comprises a force about 1.1 to about 2 times the clamping force applied during welding.

19. The method of claim 11, wherein applying the forging force comprises applying a constant compressive displacement to the resistance spot weld.

20. The method of claim 11, wherein the resistance spot weld comprises aluminum or an aluminum alloy.

21. A method comprising:
joining a first metal sheet to a second metal sheet to form a welded metal sheet; and
applying a compressive force and an electric current to the welded metal sheet to remove or prevent a defect in the welded metal sheet.

22. The method of claim 21, wherein joining the first metal sheet to the second metal sheet comprises:
positioning the first metal sheet and the second metal sheet between at least two electrodes;
applying a welding compressive force to the first metal sheet and the second metal sheet; and
applying a welding electric current to the first metal sheet and the second metal sheet at a location on the first metal sheet and the second metal sheet to join the first metal sheet to the second metal sheet.

23. The method of claim 21, wherein applying the compressive force and the electric current to the welded metal sheet to remove or prevent the defect in the welded metal sheet comprises:
applying a first amount of the compressive force to the welded metal sheet;
applying a first level of electric current to the welded metal sheet; and
adjusting the electric current from the first level of electric current to a second level of electric current, wherein the second level of electric current is less than the second level of electric current and wherein the first level of electric current or the second level of electric current corresponds to an amount of current or an amount of heat.

24. The method of claim 23, wherein adjusting the electric current from the first level of electric current to the second level of electric current comprises adjusting the electric current from the first level of electric current to the second level of electric current over a period of time.

25. A method comprising:
applying, using at least two electrodes, a first level of electric current to a first metal sheet and a second metal sheet to melt the first metal sheet and the second metal sheet such that a portion of the first and second metal sheets comprises a molten metal, wherein the first level of electric current corresponds to an amount of current or an amount of heat;
applying, using the at least two electrodes, a first amount of compressive force to the first metal sheet and the second metal sheet to join the first metal sheet to the second metal sheet to form a welded metal sheet; and
controlling a cooling rate of molten metal, wherein the cooling rate of the molten metal is slower than a cooling rate of the molten metal in a room temperature environment.

26. The method of claim 25, further comprising:
applying a second level of electric current to the welded metal sheet, the second level of electric current being less than the first level of electric current; and
applying a second amount of compressive force to the welded metal sheet, wherein the welded metal sheet is forged by applying the second level of electric current and the second amount of compressive force.

27. The method of claim 26, further comprising:
reducing the electric current from the second level of electric current to a third level of electric current while applying the second amount of compressive force, wherein the electric current is reduced from the second level of electric current to the third level of electric current over a period of time.
